(19) United States
(12) Patent Application Publication
(10) Pub. No.: US 2020/0023713 A1
(43) Pub. Date: Jan. 23, 2020

(54) ELECTRIC HEATER

(71) Applicant: Webasto SE, Stockdorf (DE)

(72) Inventors: KLAUS MÖSL, Stockdorf (DE); PAUL LEINSLE, Stockdorf (DE); VITALI DELL, Stockdorf (DE); PATRICK SPIELBERGER, Stockdorf (DE)

(21) Appl. No.: 16/494,850

(22) PCT Filed: Mar. 23, 2018
(86) PCT No.: PCT/EP2018/057414

§ 371 Date: Sep. 17, 2019

(30) Foreign Application Priority Data
Mar. 23, 2017 (DE) 10 2017 106 250.5

(51) Int. Cl. B60H 1/22; F24H 1/16; F24H 9/00; B60H 1/00

(52) U.S. Cl. CPC B60H 1/2221; F24H 1/162; B60H 2001/2287; B60H 1/00328; F24H 2250/02; F24H 9/0015

(57) ABSTRACT

The invention relates to an electric heater, in particular auxiliary heating system, for a motor vehicle, comprising a volume (15) for receiving and conducting a liquid, in particular water, as well as a liquid inlet (13) and a liquid outlet (14) in such a manner that liquid can flow into the volume (15) via the liquid inlet (13) and can flow out via the liquid outlet (14), wherein at least one heating element (16), in particular a heating resistor, and a flow-conducting device (12) is disposed in the volume (15), wherein the flow-conducting device (12) comprises at least one flow-deflecting and/or turbulence-generating device (25) for deflecting the flow and/or for generating turbulence.

The invention relates to an electric heater, in particular auxiliary heating system, for a motor vehicle and a method for operating a heater.

Electric heaters for motor vehicles, such as, for example, auxiliary heating systems, are generally known. Electric auxiliary heating systems usually have a water-carrying region (water-carrying volume) with a principal direction of flow. Furthermore, water connections are assigned to the water-carrying region, which allow water to be guided into the water-carrying region and guided out from this region. For the permanent operation of such an auxiliary heating system, it is usually necessary that a ventilation is made possible. In this connection, the utilization of the available installation space is considered to be in need of improvement.

It is therefore the object of the invention to be able to efficiently utilize the available installation space in a motor vehicle.

This object is solved by the features of claim 1.

According to a first aspect of the invention (which in particular can also be combined with the following second aspect), an electric heater, in particular an auxiliary heating system, for a motor vehicle (preferably a passenger vehicle or a lorry), comprising a volume for receiving and conducting a liquid, in particular water, a liquid inlet and a liquid outlet in such a manner that liquid can flow into the volume via the liquid inlet and can flow out via the liquid outlet, wherein at least one heating element, in particular a heating resistor, and a flow-conducting device (in particular, deflecting device) is disposed in the volume, wherein the flow-conducting device comprises at least one flow-deflecting and/or turbulence-generating device for (locally) deflecting the flow and/or for (locally) generating turbulence.

A key idea of the first aspect consists in providing a flow-conducting device (flow-conducting element) which comprises at least one flow-deflecting and/or turbulence-generating device (i.e., for example, an opening or gap and/or recess and/or projection) so that the flow can be deflected (locally) to reduce or avoid dead spaces or turbulences can be introduced, which improves the heat transfer to the at least one heating element.

Furthermore, the object is solved according to a second aspect (which in particular can also be combined with the first aspect) by an electric heater, preferably an auxiliary heating system, for a motor vehicle (e.g. passenger vehicle or lorry), comprising a volume for receiving and conducting a liquid, in particular water, a liquid inlet and a liquid outlet in such a manner that liquid can flow into the volume via the liquid inlet and can flow out via the liquid outlet, wherein at least one heating element, in particular a heating resistor, and a flow-conducting device (in particular a deflecting device) is disposed in the volume, wherein the flow-conducting device is detachably connected to a main body of the electric heater, in particular is plugged onto this.

A key idea of the second aspect lies in providing a detachable flow-conducting device (flow-conducting element) so that the flow-conducting device can be removed and/or exchanged. By this means, the flow-conducting device can be specifically or more specifically adapted to desired situations so that an effective operation of the electric heater is made possible and specifically requiring comparatively little installation space. For example, a suitable flow-conducting device can already be selected during manufacture (possibly from a plurality of different flow-conducting devices) and attached to a specific main body. A subsequent exchange would also be optionally feasible.

In principle, the (electric) heater according to the invention comprises a water heater. Such a water heater can be integrated, for example, in the cooling water circuit of a vehicle. Instead of water, a different liquid or a water-mixture (e.g. water-glycol) can also be used. The heat released in the water heater can be transferred from a heat source to the cooling water. This can be accomplished in a heat exchanger or inside a housing.

For the purpose, for example, of an interior and/or component heating, electrical energy can be used for heating the fluid (cooling water), wherein the heat can be transferred via a heat exchanger to the fluid. In principle, a heat transfer can be accomplished by means of a spatial separation of cooling-water-conducting channels and heating elements (resistance heat conductors) (in particular in the case of high-voltage heaters). Then cooling water (fluid) and heating element (resistance heat conductor) are not in direct contact with one another. In the present invention however, cooling water (fluid) and heating conductor are preferably not spatially separated (and the latter configured, for example, as immersion heater). The heating conductors (e.g. tubular heating elements, tubular heating bodies) can be integrated directly in the cooling-water-conducting (fluid-conducting) channels.

A flow-conducting device should be understood in particular as a device (an element) which is disposed inside the (fluid-conducting) volume and at least partially (co-) defines a direction of the flowing fluid. The flow-conducting device is therefore dipped into the volume in precisely the same way as the at least one heating element (in such a manner that the fluid in the volume is in contact both with the flow-conducting device and also with the at least one heating element). The flow-conducting device preferably has no function which supports and/or carries the (or any) electric heating element. In embodiments, flow-conducting device and the at least one (or all those provided) heating element(s) are not in mechanical contact or spaced apart from one another. The flow-conducting device can then be configured as a plate or cylinder and (in general) have a constant thickness (possibly apart from projections, openings and/or recesses, e.g. for the turbulence input). Preferably the flow-conducting device is at least predominantly (in terms of percentage weight) formed of metal, in particular aluminium.

A turbulence-generating device should be understood in particular as a device (an element) which is structurally conditioned in such a manner that it impresses a turbulence into the fluid stream which is conducted through the flow-conducting device, i.e., flows on and/or in and/or (around) this, which promotes through-mixing and prevents the formation of so-called dead spaces (or at least reduces a corresponding probability for this).

A flow-deflecting device should be understood in particular as a device which locally (possibly at several locations) deflects the flow (in particular without generating turbulences). The flow-deflecting device can to this end preferably have a plurality of openings (gaps) and/or recesses and/or projections, which deflect the liquid stream into regions (dead spaces), which would not be reached or through which flow would not take place without corresponding flow-deflecting device(s).

The flow-conducting device can have the form of a perforated cylinder. The perforated cylinder preferably has an elongate-hole-type cross-section. The length of the cross-section is preferably 1.5 times, further preferably at least 2.5 times and/or at most 10 times, preferably at most 5 times as large as the width. An axial length of the flow-conducting device is preferably at least 0.5 times, preferably at least 1.0 times and/or at most 3.0 times, preferably at most 1.8 times as large as the length of the cross-section. Alternatively or additionally, the axial length of the flow-conducting device is preferably at least 1.8 times, further preferably at least 3.0 times and/or at most 12.0 times, preferably at most 6.0 times as large as the width of the cross-section.

Furthermore, the flow-conducting device preferably comprises a plurality of (e.g. circular) holes, which further preferably are arranged in a grid or mesh-like manner or in (several) rows, for example, at least 5 or at least 10 rows and/or several columns, for example, at least 5 or at least 10 columns. The “lines” preferably extend in the circumferential direction of the perforated cylinder, the “columns” in the axial direction. For example, overall at least twenty or at least a hundred holes can be provided. The holes can in each case by themselves or overall form a flow-deflecting device which (locally) deflects the flow so that dead spaces are avoided or at least reduced.

Individual or several or all of the holes can have a round or non-round, e.g. elliptical, oval and/or polygonal, in particular quadrangular and/or triangular cross-section and/or a cross-section as described in the following embodiments.

A longitudinal axis of the perforated cylinder can extend transversely to a longitudinal axis of a/the housing. A second flow-conducting device (in particular, additionally to the perforated cylinder) can be provided in the form of a dividing wall, in particular a dividing plate. The second flow-conducting device can be arranged on at least approximately half the axial length (optionally+/−10% of the axial length) of the perforated cylinder. Furthermore, the second flow-conducting device can be at least substantially perpendicular to the axial direction of the perforated cylinder.

The first (perforated cylinder) and/or second flow-conducting device can (in each case by themselves or in combination) form a deflecting device.

The volume can be divided into two partial volumes by the second flow-conducting device (dividing wall or dividing plate). In this case, the second flow-conducting device preferably runs straight from one (longitudinal) side wall of the housing to an opposite side wall (perpendicular to these side walls). Liquid inlet and liquid outlet can be arranged on the same side wall (and specifically preferably next to one another relative to a longitudinal extension of the housing). Specifically liquid inlet and liquid outlet can be located in an end section of a side wall.

Overall, liquid can flow around the (first) flow-conducting device (perforated cylinder), through the (first) flow-conducting device (perforated cylinder) and/or around an edge of the (second) flow-conducting device so that overall a multitude of “paths” are available to the liquid or dead spaces can be avoided or at least reduced.

The heating element (in particular in the form of a heating coil or heating tube) is preferably arranged around the (first) flow-conducting device (perforated cylinder. The (first) flow-conducting device 12 can be in (mechanical) contact with the heating element, for example, plugged into this but is preferably spaced apart from the heating element. As a result, the flow of liquid can be further improved with a view to the heat transfer.

Furthermore, the (first) flow-conducting device (perforated cylinder) can be detachably connected to a main body, in particular by plugging on or in. The (first) flow-conducting device (perforated cylinder) can be held by the second flow-conducting device, in particular plugged into the second flow-conducting device. The second flow-conducting device can per se be detachably or undetachably (e.g. by plugging or by welding) connected to the main body.

Preferably, the flow-conducting device comprises a deflecting device, in particular at least one dividing wall, or is configured as a deflecting device, in particular dividing wall, preferably in such a manner that liquid flowing at the liquid inlet to the liquid outlet is deflected so that a flow path is enlarged. A key idea of this further development lies in forcing the liquid flowing through the volume through the deflecting device onto a path so that a “shortening” of the liquid from the liquid inlet to the liquid outlet is (at least largely) excluded. As a result, a good (at least largely complete) and defined flow around the heating element can be achieved (in particular independently of an installation position). This type of flow around the heating element is therefore (at least largely) independent of the installation position. Nevertheless, a sufficient ventilation can also be achieved in various (e.g. two or three different) installation positions. Overall, available installation space can thus be utilized more efficiently (by appropriate orientation of the electric heater). Overall, the electric heater can be used variably.

The volume (water-conducting region) is preferably formed by a container in which (at least in sections) the heating element or in particular the heating resistor is arranged. The volume or the container can in particular be rectangular (possibly with rounded edges) or (circular) cylindrical. The container can optionally be formed in one piece with the deflecting device (preferably monolithically). Alternatively the container can be composed of a plurality of element and/or container and deflecting device can be formed by separate components. The container can (at least in sections) be fabricated from metal and/or plastic.

Liquid inlet and/or outlet preferably have a round cross-section.

A heating element is in particular to be understood as an element which enables a heating of a liquid in the volume so that the temperature of the liquid upon exiting from the liquid outlet is increased compared with the temperature on entering through the liquid inlet. Such a heating element is preferably sealed (i.e. in particular configured without fluid channels integrated therein). Preferably the heating element is an (electrical) heating resistor, i.e. a structure which becomes heated when an electric current is applied, wherein the heat can then be delivered to the liquid in the volume. An arrangement of the heating element in the volume should be understood in particular as an arrangement in which the heating element projects into an interior of the volume. However, this can also comprise an arrangement in which the heating element is arranged on an inner surface of a wall of the volume or is defined by the wall itself. In a specific embodiment, precisely one liquid inlet and one liquid outlet is provided. It is also conceivable that more than one liquid inlet and/or more than one liquid outlet is provided.

A deflection by the deflecting device should be understood in particular to mean that a direct path between liquid inlet and liquid outlet is at least partially blocked by the deflecting device so that the liquid is at least partially forced onto a detour in order to arrive at the liquid outlet from the liquid inlet by flowing through the volume. By this means, it should not be excluded that at least a certain fraction of the liquid flowing through the volume can also flow on the direct path from liquid inlet to liquid outlet (for example, through one or more opening/s in the deflecting device, which allows at least a small portion of the liquid to flow from the liquid inlet to the liquid outlet without a detour). At least the predominant part of the liquid should however be forced onto a detour by the deflecting device. This detour should preferably be at least twice as large, further preferably at least four times as large as a (potential) direct path between liquid inlet and liquid outlet.

In specific configurations, the flow-conducting device (deflecting device) can extend over at least 25%, even further preferably at least 50% and/or at most 98%, preferably at most 92%, of a distance between two opposite (e.g. parallel-running) wall sections of the housing. In a, for example, (circular)-cylindrical configuration, the flow-conducting device (deflecting device) can preferably extend over at least 25%, in particular at least 50% and/or at most 98%, preferably at most 92% of a length of the cylinder.

Preferably the flow-conducting device and/or the main body has at least one clamping device, comprising in particular at least one plug-in flap. The clamping device (plug-in flap) preferably cooperates with at least one corresponding device (e.g. edge and/or strip-like projection) in such a manner that the flow-conducting device is held in a clamping manner. By this means, the flow-conducting device can be attached and held securely in a simple manner.

The flow-deflecting and/or turbulence-generating device preferably has at least one flap (in particular projecting from the flow-conducting device). The flap can preferably be formed at least in part by a section of the flow-conducting device being at least partially cut out and/or at least partially placed thereon (bent).

In a preferred embodiment, the at least one flap is arranged on an edge of the (preferably plate-shaped) flow-conducting device and can be pivoted outwards from a principal surface of the flow-conducting device (e.g. by bending). As a result, the flow-deflecting and/or turbulence-generating device can be adapted in a particularly simple manner (in particular also after manufacture). Alternatively or additionally, at least one flap can also be provided, which is not provided on an edge of the flow-conducting device. Here also however, the flap is preferably conditioned so that it can be placed at various distances outwards (so that it can project to various distances).

In one specific embodiment, the flow-deflecting and/or turbulence-generating device comprises at least one turbulator. The turbulator preferably extends perpendicularly onto a plane predefined by the (in particular plate-shaped) flow-conducting device. The turbulator can have a cylindrical shape and/or have a circular cross-section.

In one embodiment, at least one projection can project from the flow-conducting device by at least twice, preferably at least three times a thickness of the flow-conducting device. A thickness of the flow-conducting device (with varying local thickness) should be understood in particular as an average thickness or a thickness of a largest cohesive region of constant thickness among all cohesive regions of constant thickness. Alternatively or additionally, the projection can project from the flow-conducting device by at least 2 mm, preferably by at least 3 mm and/or at most 100 mm, preferably at most 50 mm, further preferably at most 10 mm.

In embodiments, the flow-deflecting and/or turbulence-generating device (in particular in the form of a projection) is closer to a downstream end of an inflow surface of the flow-conducting device than an upstream end or conversely. An inflow surface of the flow-conducting device should be understood in particular as a surface which comes (directly) in contact with fluid flowing past. “Upstream” and “downstream” relate in this context to a principal flow direction in which any turbulences or local deviations are not taken into account. For example, the liquid inlet is located upstream in this sense and the liquid outlet is located downstream.

The flow-deflecting and/or turbulence-generating device preferably has at least one opening (gap), further preferably inside an edge (or at a distance from this). Alternatively or additionally, the flow-deflecting and/or turbulence-generating device can have at least one recess, preferably on an/the edge. Alternatively or additionally, the flow-deflecting and/or turbulence-generating device can have at least one projection. The projection can, for example, be conditioned so that it is inclined downstream or upstream (here also again relative to a principal direction of flow). Particularly preferably a projection and a corresponding opening and/or recess can be combined so that the projection directly adjoins the opening or recess or borders this at least partially. As a result, turbulence can be introduced in a simple manner. In manufacture, for example, the projection and the corresponding opening/recess can be manufactured in only one step (for example, by cutting out from a metal sheet).

In the embodiments, the flow-deflecting and/or turbulence-generating device is formed partially or exclusively in a distal half of the flow-conducting device. A distal half of the flow-conducting device is to be understood as that half which is at a greater distance from an assembly region of the flow-conducting device (for example, on a lid or flange part or other housing element). It is thereby possible that the liquid initially flows over a certain section (in each case at least over the corresponding proximal half) of the flow-conducting device along this and turbulences are only introduced in a distal region. By this means an efficient operation can be achieved.

The flow-conducting device can comprises at least one flow-conducting plate (deflecting plate) and/or at least one flow-conducting cylinder (deflecting cylinder). The flow-conducting plate preferably extends parallel to a longitudinal axis of the volume or of a corresponding housing (which defines the volume). The flow-conducting cylinder is preferably formed perpendicular to a longitudinal axis of the housing. A (radial) cross-section of the flow-conducting cylinder can be configured to be circular or elliptical or elongate-hole-shaped. A length of the cross-section can be at least twice, preferably at least four times as large as a width of the cross-section. The flow-conducting cylinder is preferably a hollow cylinder.

The flow-conducting device can have at least two wall sections which are (at least substantially) parallel to one another, namely a first wall section and a second wall section. Preferably at least one section of the heating conductor extends between the wall sections. Preferably a first flow-deflecting and/or turbulence-generating device (in particular opening) is provided on (in) the first wall section and/or a second flow-deflecting and/or turbulence-generating device (in particular opening) is provided on the second wall section. First and second flow-deflecting and/or turbulence-generating device (openings) are preferably arranged (partially or completely) offset with respect to one another or (alternatively) in alignment with one another. An aligned arrangement should be understood in particular such that all the straight lines which, on the one hand, are perpendicular to the first or second wall section and pass through the flow-deflecting and/or turbulence-generating device (opening) also pass through the second flow-deflecting and/or turbulence-generating device (opening). Insofar as an offset is present, this can be formed partially or completely. A partial offset should be understood such that a subset of the above-defined straight lines only passes through the first flow-deflecting and/or turbulence-generating device (opening) and a further subset passes both through the first flow-deflecting and/or turbulence-generating device (opening) and the second flow-deflecting and/or turbulence-generating device (opening). A complete offset should be understood as an arrangement in which all the above-defined straight lines only pass through the first flow-deflecting and/or turbulence-generating device (opening) and not the second flow-deflecting and/or turbulence-generating device (opening) or any further flow-deflecting and/or turbulence-generating device (opening) on the second wall section. As a result of such an offset of the flow-deflecting and/or turbulence-generating devices (openings), an additional (superposed) velocity component can be produced, whereby the heat transfer to the liquid (the fluid) can be further increased.

The liquid inlet and the liquid outlet can be arranged adjacent to one another and/or are arranged on the same side of the electric heater and/or are arranged offset with respect to one another. As a result of an offset arrangement (for example, on the same side), a further velocity component can be impressed on the flowing liquid, which can further improve the heat transfer.

According to a further aspect of the invention (which can preferably be combined with the above first and/or second aspect), the object is solved by an electric heater (in particular an auxiliary heating system) for a motor vehicle, preferably of the type described above, wherein the electric heater comprises a volume for receiving and conducting a liquid, in particular water, a liquid inlet and a liquid outlet in such a manner that liquid can flow into the volume via the liquid inlet and can flow out via the liquid outlet, wherein a heating resistor is arranged in the volume, wherein the electric heater is configured in such a manner that it can be ventilated in at least two, preferably at least three different installation positions. According to a basic idea of the invention, an electric heater is proposed, which is configured so that it functions (permanently) in various installation positions, in particular can be ventilated. Furthermore, the electric heater should be configured so that it can also be operated (efficiently) in the plurality of installation positions, i.e. a corresponding heat transfer can take place. Finally, the electric heater is also configured so that it can be mounted in the various installation positions (installation orientations). This assumes corresponding mounting devices which also enable mounting in several installation positions (installation orientations). In this case, it should be noted that different forces act in different installation positions since gravity is always directed downwards.

Therefore initially a first installation position can be made possible. A second installation position can optionally be achieved by rotation of the electric heater from the first installation position by 90 degrees. An optionally third installation position can be achieved by rotation through 90 degrees from the second installation position about a second (different) axis. The second axis is preferably perpendicular to the first axis. For example, the first axis can be parallel to a longitudinal extension of the electric heater and the second axis can be perpendicular thereto (i.e. extend transversely). In electric heaters, in particular electric auxiliary heating systems of the prior art, in particular the type of configuration of the through-flow and the arrangement of the water connections prevents various installation positions of the heater from being able to be realized. This restriction is now overcome according to the invention. In general, various installation positions means various orientation of the electric heater in relation to the gravity vector.

The deflecting device (the deflecting element, in particular the dividing wall) can be formed of metal and/or configured as plate-shaped or as a plate. The deflecting device can comprise, at least in sections, a (preferably straight) metal sheet. An outline of the deflecting device can be quadrangular.

The flow-conducting device or deflecting device (the deflecting element) can be spaced apart from the heating element or not connected to this, in particular not in contact with at least one or several or all the heating element(s).

The flow-conducting device or deflecting device can be mounted at a proximal end inside the electric heater, in particular on a housing or housing part of the electric heater. A distal end is preferably free.

Preferably liquid inlet and liquid outlet are adjacent to one another. Alternatively or additionally, liquid inlet and liquid outlet can be arranged on the same side (for example, in the same wall, in particular side wall) of the electric heater (or of a container forming the volume). “Adjacent to one another” should be understood in particular as a distance between liquid inlet and liquid outlet of less than 5 cm. For example, liquid inlet and liquid outlet can be arranged on a longitudinally extending wall of the electric heater (or the volume), in particular on one end of such a longitudinal wall, wherein this end can be defined by a region of 20% of the longitudinal extension (when viewed from an end edge). As a result of such an arrangement, on the one hand, a ventilation can be carried out effectively in various installation positions and nevertheless, the electric heater can operate efficiently since an adequate flow around the heating element in various installation positions is ensured by the deflecting device. Overall, an efficient operation in various installation positions, i.e. utilizing an available installation space is made possible.

The liquid inlet and the liquid outlet can have a distance from one another which is (significantly) smaller than a maximum possible distance between two points inside the volume, for example, less than half, preferably less than a quarter, preferably less than an eighth of this maximum possible distance from one another. In a (perfect) cuboid, for example, the maximum possible distance would correspond to the spatial diagonals.

Preferably the liquid outlet is arranged/can be arranged in at least three different installation positions either at the same height or above the liquid inlet. In a specific embodiment, the liquid inlet is arranged/can be arranged in two installation positions at the height of the liquid inlet and in a third installation position, above the liquid inlet. As a result, an effective operation and also a ventilation is made possible in a simple manner in three different installation positions.

If liquid outlet and liquid inlet are arranged on the same wall (for example, in the case of a cuboid on the same side wall or in the case of a cylinder on the lateral surface) of the volume, liquid outlet and liquid inlet are preferably arranged at the same height of this wall or are arranged so that a connecting line runs between liquid inlet and liquid outlet parallel to a wall boundary.

The flow path enlarged by the flow-conducting device can be at least double, preferably at least four times, further preferably at least eight times, even further preferably at least sixteen times as long as a distance between liquid inlet and liquid outlet.

Preferably the deflecting device extends inside the volume over at least 50%, preferably at least 80%, even further preferably at least 90% and/or at most 95%, preferably at most 92% of a (longitudinal) extension of the volume.

In one specific embodiment, the flow-conducting device or deflecting device divides the volume into two partial volumes, which are preferably interconnected by at least one or precisely one connecting opening. The connecting opening can preferably be at a greater distance from the liquid inlet than the liquid outlet (from the liquid inlet). Alternatively or additionally, a heating element or a section of such can be arranged in both partial volumes. A dividing surface defined by the flow-conducting device or deflecting device (dividing wall) preferably has an opening or openings over at most 20%, further preferably at most 10% (of the area). In other words, the dividing surface is predominantly sealed. In a specific embodiment, a gap between the partial volumes can be present exclusively at one distal end (pointing away from the liquid inlet) of the flow-conducting device or deflecting device. Optionally however, (at least smaller) gaps can also be arranged further in the direction of the liquid inlet, for example, to improve the ventilation and/or the inflow of individual regions of the heating element.

The flow-conducting device or deflecting device (dividing wall) can be arranged and oriented in such a manner that a cross-section of a liquid guidance perpendicular to a longitudinal extension of the deflecting device tapers in a funnel shape or widens starting from the liquid inlet and/or the liquid outlet. The flow-conducting device or deflecting device (dividing wall) can run diagonally from a first side to a second (opposite, optionally parallel running) side. As a result of such a (funnel-like) tapering or widening, a flow through the volume can be effectively realized (even in different installation positions), which overall improves the efficiency.

A housing which defines the volume and the flow-conducting device or deflecting device can be implemented as a one-part (monolithic) component. As a result, the manufacturing expenditure can be reduced and (additionally) sealing points can be avoided.

Preferably at least one tubular heating body and/or at least one layer heater is provided as heating element or part of the same. A tubular heating body can be understood in particular as a meandering and/or screw- and/or spiral-shaped profile of an (optionally sealed, i.e. configured without inner fluid channels) electrical conductor. A layer heater is in particular a heating element in which an electrical conductor is applied flat (over, for example, at least 5 cm² or 10 cm²) to a base (for example, housing inner wall) and is laid for heating with electric current. For example, reference is made in this regard to WO 2013/186106 A1 and WO 2013/030048 A1. Heaters are described there which have an electrical heating layer which is heated when an electric voltage is applied (or a current flows). The use of a tubular heating body in particular allows the implementation of an easy-to-fabricate geometry.

The aforesaid object is further solved by a motor vehicle comprising an electric heater of the type described above.

Furthermore, the object is solved by a method for operating a heater of the type described above or a motor vehicle of the type described above, wherein the liquid flows in through the liquid inlet and flows out from the liquid outlet at elevated temperature. The liquid flowing out from the volume is preferably used to heat an interior of a motor vehicle, in particular a passenger compartment and/or for heating (or pre-heating) a drive element, in particular a motor.

According to a further aspect of the invention, the use of a heater of the type described above as pre-heating device and/or additional device, in particular as an auxiliary heating system is proposed.

According to a further aspect of the invention, a set, comprising the above heater (in which the at least one flow-conducting device is optionally released or separated) is proposed wherein the set comprises at least a first and a second flow-conducting device which differ from one another with regard to their structure, preferably by the structure of at least one flow-deflecting and/or turbulence-generating device. First and second flow-conducting device can fundamentally each be configured as described above in relation to the heater. Preferably first and second flow-conducting device can be exchanged for one another and/or used together. For example, first and second flow-conducting device can differ with regard to a size and/or shape of the same and/or with regard to a size and/or shape and/or number of flow-deflecting and/or turbulence-generating devices (in particular differ with regard to a size and/or shape and/or number of projections or openings or recesses). A comparatively good adaptation of the heater to the desired usage location ca be achieved in a simple manner by the present set.

The heating element (the electrical heating resistor) can be supplied with current via a power supply of the motor vehicle (for example, a vehicle battery) and/or via an (external) power supply network.

The partial volumes comprise in each case at least 10%, preferably at least 20%, even further preferably at least 40% of the (entire) volume.

The volume can comprise at least 200 cm³, preferably at least 1000 cm³, Furthermore, the volume (in a longitudinal extension) can be at least 5 cm, preferably at least 12 cm long. An upper limit can be 40 cm, preferably 30 cm. A width and/or depth and/or (e.g. in a cylindrical design) a diameter can, for example, be at least 4 cm, preferably at least 6 cm. A corresponding upper limit can be 12 cm, preferably 8 cm.

For mounting at the installation/attachment site, the electric heater preferably has corresponding fastening devices (e.g. bores).

The flow-conducting device can have (precisely) one or more metal sheets (perforated sheets). Through the bores (openings) a punctuate (local-area) control of the flow can take place or (local) dead areas can be avoided. Furthermore, a perforated sheet can be produced cost-effectively.

In principle, the flow-deflecting and/or turbulence-generating device (e.g. comprising a plurality of holes) allows local requirements for the flow to be taken into account. In particular, the (locally) entering fluid flow (cooling water mass flow) can be adjusted accordingly. The fluid flow can be variably divided by number, diameter and positioning of flow-deflecting and/or turbulence-generating device (such as, for example, projections, holes, in particular bores, recesses).

Optionally provided openings of the flow-deflecting and/or turbulence-generating device can have various forms (e.g. circular hole and/or elongate hole and/or the form of a polygon, in particular a quadrilateral and/or a triangle). An optionally configured quadrilateral is preferably elongated (one length exceeds in particular at least twice or at least five times a width). Elongate holes or (elongated) quadrilaterals are preferably oriented transversely to a principal direction of flow. Elongated holes or elongated quadrilaterals are particularly advantageous when longer (straight) sections of the heating element (in particular the heater) are present.

By means of the invention, a (targeted) secondary flow can be impressed in an effective manner on a primary flow (principal flow) so that the through-mixing and circulation in the fluid flow (cooling water flow) can be drastically increased. The flow of the fluid can preferably be influenced in a spatial depth (i.e. perpendicular to the flow-conducting device, in particular deflecting device) of at least 5 times or at least 15 times a thickness of the flow-conducting device (deflecting device).

A secondary flow is therefore particularly preferably formed. Furthermore, (additional) large-scale eddy structures on the macro level can be introduced into the fluid (cooling water).

In each case, an increased through-mixing and circulation has an advantageous effect on the heater operation.

Unfavourable boiling processes such as, for example, partial or complete film boiling can be comparatively well prevented by targeted introduction of turbulence into the fluid flow (cooling water flow).

The introduction of turbulence is preferably based on the principle of a flow detachment, followed by a vortex cascade. This vortex cascade (secondary flow) can be superposed on the primary flow and be anchored in such a manner that the heat transfer coefficient in the heater is kept (permanently) high. As a result, a controlled heat removal from the corresponding heating element can be (reliably) accomplished and optionally a (controlled) nucleate boiling. Particularly preferably this can be achieved by at least one clearance and/or a sharp edge contour in or on the flow-conducting device (deflecting device) so that one or more detachment edges are formed.

The flow-deflecting and/or turbulence-generating device preferably comprises a (rectangular) opening (e.g. punching) which lies inside an outer contour of the flow-conducting device (deflecting device) (similar to a window). Alternatively or additionally, the flow-deflecting and/or turbulence-generating device can have a cascade of openings which lie within an outer contour of the flow-conducting device (deflecting device) (for example, a cascade of slots). Alternatively or additionally, the turbulence device can have a register of appearances (e.g. rectangular or trapezoidal) which extend, for example, along a deflecting edge (distal end) of the flow-conducting device (the deflecting device) (can then be implemented, for example, in comb form at a corresponding free end). Alternatively or additionally, (local) perforations or through-holes of the flow-conducting device (the deflecting device) can be present (similar to a screen).

Overall, an advantageous through-mixing can be accomplished by the invention to (drastically) increase any heat transfer. Fluid (liquid or cooling water) is sucked or circulated from dead water areas. Higher heating powers can be achieved both globally and also locally. The safety with respect to unfavourable boiling process (e.g. partial or complete film boiling) is increased.

Furthermore, the flow can be controlled locally (favourably). Manufacture (in particular using a perforated metal sheet) is comparatively cost-effective.

The fluid flow (cooling water flow) can be influenced simply in a targeted manner (with the result that a larger operating window is allowed). Undesired or critical operating states can be systematically avoided. The increased expenditure in the course of the manufacture of a flow-conducting device (a deflecting device) is low.

In general, (local) bypass regions can be introduced (with the result that a defined reduction of dead water areas is made possible).

Preferably the flow-conducting device is configured to be detachable (in particular is configured to be able to be plugged in). Alternatively however, this can also be attached in one piece in a different manner, for example, welded to a/the main body.

Overall an advantageous modular construction system (for the heater architecture) can be made possible.

Compared to the invention, solutions of the prior art have various disadvantages. The shaping of the flow-conducting devices is usually predefined by manufacturing possibilities alone (at the supplier). Local boiling processes inside the heater (in particular inside a heat exchanger and housing) have an unfavourable effect on the heat removal through the fluid (cooling water). This can therefore result in local overheating. It can also result in undesired operating states which are perceived as perturbing (for example, a formation of vapour bubbles; steam hammer in the heater). At very high heat flow densities and with the onset of film boiling, the temperature of the heating unit can increase significantly and cause destruction of the heating unit. In this case, it should be born in mind that for the usual heating power requirement of mobile electric heaters (for example, with a power of 1 to 5 kW) a specific heat flow density (of at least about 15 to 20 W/cm²) should not be exceeded for lifetime and safety reasons. Thus (and as a result of the general requirement for a compact heater), the usual heating elements are usually configured to be spiral (as tubular heating bodies) in order to obtain a specific wetted surface. During the flow around such complex spiral tubular heating bodies, the local separation regions then form. In such bridge areas, the (relatively) poor heat transfer to the fluid results in (local) overheatings of the heating conductor and an undesired incipient strong boiling or steam hammers. This problem imposes an upper limit on the heating power in the prior art.

The invention is hereafter described in detail with reference to exemplary embodiments, which are explained in detail with reference to the diagrams. In the figures:

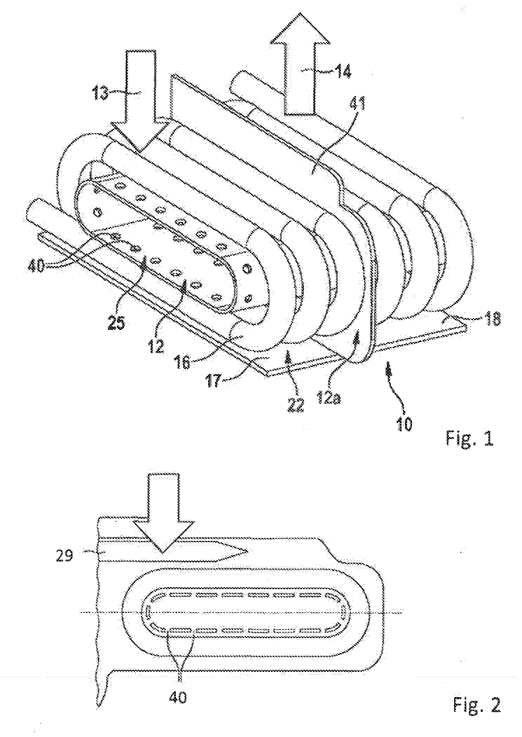

FIG. 1 shows a section of a first embodiment of the heater according to the invention;

FIG. 2 shows a side view of the embodiment according to FIG. 1;

FIG. 3 shows a further embodiment of an electric heater according to the invention in an oblique view (without housing);

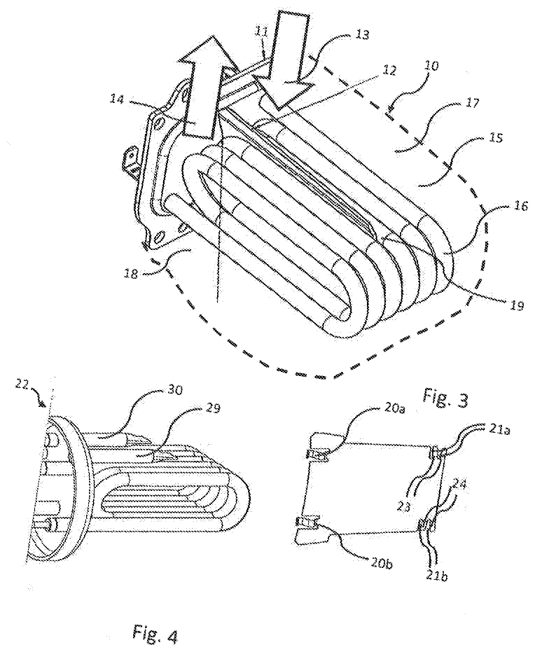

FIG. 4 shows an exploded view of a further embodiment of a heater according to the invention in an oblique exploded view;

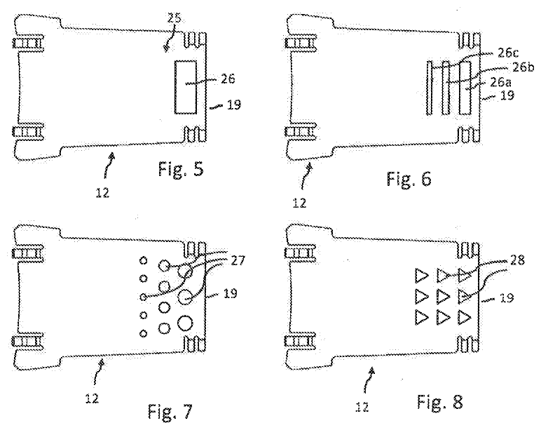

FIG. 5 shows a flow-conducting device (deflecting device) according to the invention;

FIG. 6 shows a flow-conducting device (deflecting device) similar to FIG. 5 according to a further embodiment;

FIG. 7 shows a flow-conducting device (deflecting device) similar to FIG. 5 according to a further embodiment;

FIG. 8 shows a flow-conducting device (deflecting device) similar to FIG. 5 according to a further embodiment;

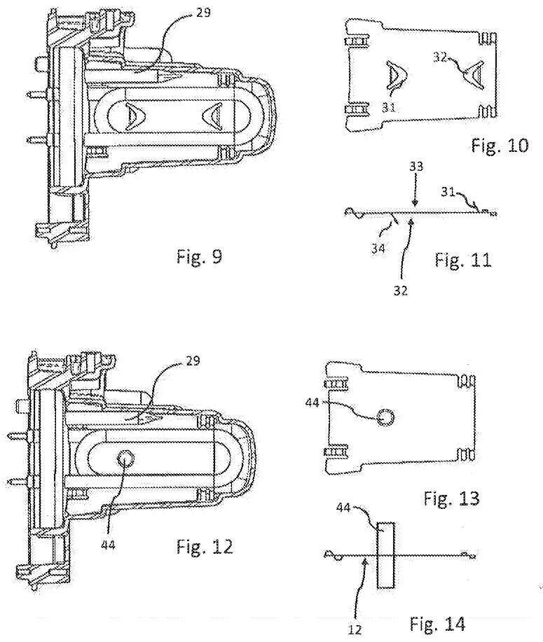

FIG. 9 shows a further embodiment of the heater according to the invention in a sectional view;

FIG. 10 shows the flow-conducting device according to FIG. 9 in a plan view;

FIG. 11 shows the flow-conducting device (deflecting device) according to FIG. 10 in a side view;

FIG. 12 shows a further embodiment of the heater according to the invention in a sectional view;

FIG. 13 shows a plan view similar to FIG. 10 for the heater according to FIG. 12;

FIG. 14 shows a side view similar to FIG. 11 for the heater according to FIG. 12;

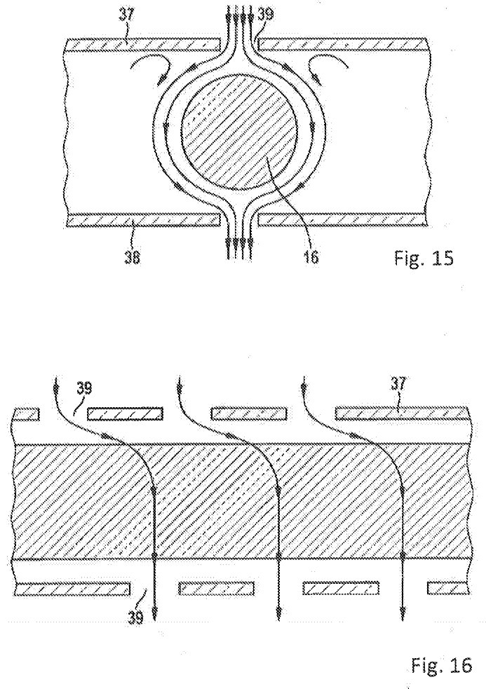

FIG. 15 shows a schematic sectional view of an arrangement of a heating conductor section inside the heater;

FIG. 16 shows a further schematic view of a section of an arrangement of a heating conductor inside the heater;

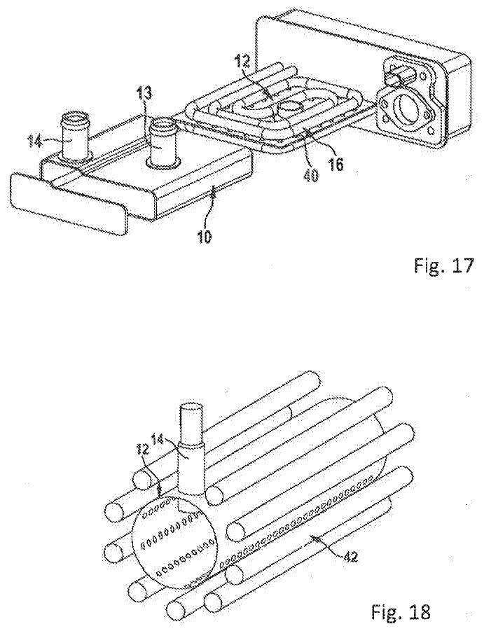

FIG. 17 shows a further embodiment of the heater according to the invention in an oblique view (partially in exploded view); and

FIG. 18 shows a section of a heater according to the invention.

In the following description the same reference numbers are used for the same parts or parts having the same effect.

FIGS. 1 and 2 show an embodiment of a heater according to the invention (in sectional view).

This heater has a housing 10 and possibly a cover or flange part (not shown). Liquid inlet 13 and liquid outlet 14 are symbolized by corresponding arrows.

The housing 10 can be (approximately) rectangular (optionally with rounded edges) or (circular) cylindrical so that a corresponding volume 15 which is defined by the housing 10 is also configured to be rectangular (with rounded edges) or (circular) cylindrical. Located inside the housing 10 or in the volume 15 is a heating element (heating device) 16 which in the present exemplary embodiment comprises a tubular heating body. This heating element 16 heats up as a result of electric current so that a liquid (water) can also be heated in the volume 15.

A flow-conducting device 12 in the form of a perforated cylinder is shown in the oblique view according to FIG. 1. The perforated cylinder preferably has an elongate-hole-type cross-section. The length of the cross-section is preferably 1.5 times, further preferably at least 2.5 times and/or at most 10 times, preferably at most 5 times as large as the width.

An axial length of the flow-conducting device 12 is preferably at least 0.5 times, preferably at least 1.0 times and/or at most 3.0 times, preferably at most 1.8 times as large as the length of the cross-section. Alternatively or additionally, the axial length of the flow-conducting device 12 is preferably at least 1.8 times, further preferably at least 3.0 times and/or at most 12.0 times, preferably at most 6.0 times as large as the width of the cross-section.

Furthermore, the flow-conducting device according to FIG. 1 comprises a plurality of holes 40 which are arranged in (a plurality of) rows, for example, at least 5 or at least 10 rows and several columns, for example, at least 5 or at least 10 columns. The “lines” preferably extend in the circumferential direction, the “columns” in the axial direction. For example, overall at least twenty or at least a hundred holes 40 can be provided. The holes 40 overall form a flow deflecting device 25, which locally deflects the flow so that dead spaces are avoided or at least reduced.

Individual or several or all of the holes can have a round or non-round, e.g. elliptical, oval and/or polygonal, in particular quadrangular and/or triangular cross-section and/or a cross-section as described in the following embodiments.

It can furthermore be identified in FIGS. 1 and 2 that a longitudinal axis of the flow-conducting device 12 extends transversely to a longitudinal axis of the housing 10 (shown by the dashed line in FIG. 2). A second flow-conducting device 12a can be provided in the form of a dividing wall, in particular a dividing plate. The second flow-conducting device 12a can be arranged on at least approximately half the axial length (optionally+/−10% of the axial length) of the flow-conducting device 12. Furthermore, the flow-conducting device 12a can be at least substantially perpendicular to the axial direction of the flow-conducting device 12.

The first and/or second flow-conducting device 12, 12a can (in each case by themselves or in combination) form a deflecting device.

The volume 15 is divided into two partial volumes 17, 18 by the second flow-conducting device 12a (dividing wall or dividing plate). In this case, the second flow-conducting device 12a preferably runs straight from one (longitudinal) side wall of the housing 10 to an opposite side wall (perpendicular to these side walls). Liquid inlet 13 and liquid outlet 14 can be arranged on the same side wall (and specifically next to one another relative to a longitudinal extension of the housing 10). Specifically liquid inlet 13 and liquid outlet 14 can be located in an end section of a side wall.

Overall, liquid can flow around the flow-conducting device 12, through the flow-conducting device 12 and/or around an edge 41 of the flow-conducting device 12a so that overall a multitude of “paths” are available to the liquid and/or dead spaces can be avoided or at least reduced.

The heating element 16 (here in the form of a heating coil or heating tube) is preferably arranged around the flow-conducting device 12. The flow-conducting device 12 can be in (mechanical) contact with the heating element, for example, plugged into this but is preferably spaced apart from the heating element 16. As a result, the flow of liquid can be further improved with a view to the heat transfer.

Furthermore, the flow-conducting device 12 can be detachably connected to a main body 22, in particular by plugging on or in. The flow-conducting device 12 can be held by the second flow-conducting device 12a, in particular plugged into the second flow-conducting device 12a. The second flow-conducting device 12a can per se by detachably or undetachably (e.g. by plugging or by welding) connected to the main body, for example, as described by reference to FIG. 3 or 2 for the flow-conducting device there.

A guide element 29 can be further identified in FIG. 2, which will be explained in detail further below with reference to FIG. 2 (a further guide element can be provided, as described in FIG. 4, there provided with the reference number 30). FIG. 3 shows a further embodiment of the heater according to the invention. This comprises a housing 10 (only shown by the dashed line) and a cover or flange part 11. A flow-conducting device 12 (in the form of a dividing plate) is located on the flange part 11. Liquid inlet 13 and liquid outlet 14 are symbolized by corresponding arrows.

The housing 10 can be configured to be (approximately) rectangular (optionally with rounded edges) or (circular) cylindrical so that a corresponding volume 15, which is defined by the housing 10, is configured to be rectangular (with rounded edges) or (circular) cylindrical. Located inside the housing 10 or in the volume 15 is a heating element (heating device) 16 which in the present exemplary embodiment comprises a tubular heating body. As a result of the electric current, this heating element 16 heats up so that a liquid (water) can also be heated in the volume 15.

The volume 15 is divided into two partial volumes 17, 18 by the flow-conducting element 12 (dividing wall or dividing plate). The flow-conducting device 12 runs in this case straight (obliquely) from a (longitudinal) side wall of the housing 10 to an opposite side wall. Liquid inlet 13 and liquid outlet 14 can be arranged on the same side wall (and specifically next to one another relative to a longitudinal extension of the housing 10). Specifically liquid inlet 13 and liquid outlet 14 can be located in an end section of a side wall.

The heating element (the heating device) 16 preferably extends over (almost) the entire longitudinal extension of the volume 15 (at least over at least 90% of this longitudinal extension, possibly over a maximum of 98% of this longitudinal extension). The heating element 16 extends in particular from the cover or flange part 11, through which optionally heating element connections run, to (almost) the opposite wall. A distal end 19 of the flow-conducting device 12 preferably extends less far than the heating element 16. In each case, liquid (water) can flow around the distal end 19 through a section located between the distal end 19 and the corresponding wall section of the housing 10, from one partial volume 17 into the other partial volume 18 so that liquid can flow from the liquid inlet 13 into the liquid outlet 14.

The flow-conducting element (flow-conducting device) 12 can be configured in a firmly bonded manner on the flange part 11 (for example, welded to this).

Furthermore, the flow-conducting device 12 preferably has at least one turbulence device which can be configured as described in the following figures (in particular in FIGS. 2 to 12).

FIG. 4 shows a section of a further embodiment of a heater according to the invention. In this embodiment the flow-conducting device 12 can be connected to a main body 22 of the heater via clamping devices 20a, 20b (clamping tabs). Furthermore, the flow-conducting device 12 has clearances 21a, 21b (adjacent to its distal end 19). The clearances 21a, 21b (in particular a plurality thereof in each case, e.g. two) can be arranged on the two longitudinal edges of the flow-conducting device 12.

The clearances 21a, 21b further define tabs 23, 24 which are pivotable (in particular by bending) so that specifically the turbulence thereby introduced can be improved/adapted. Overall the structures 21a, 21b, 23 and 24 form a corresponding flow-deflecting and/or turbulence-generating device 25.

Furthermore, guide elements 29, 30 are provided in FIG. 4 which taper (at the distal end thereof) in sections and advantageously make it possible that the fluid flows through the liquid inlet 13 and the liquid outlet 14 divide close to the respective opening (inlet and outlet) or accordingly combine and are displaced at least in terms of components from the liquid inlet in the direction of a rear end of the housing 10 or are guided from this rear end in the direction of the liquid outlet.

In the flow-conducting device 12 according to FIG. 5, the flow-deflecting and/or turbulence-generating device 25 comprises, in addition to the structures 21a, 21b, 23 and 24 according to FIG. 4, an elongate hole 26 inside the flow-conducting device 12 (in the vicinity of the distal end 19 or in a corresponding distal half of the same).

FIG. 6 shows an embodiment similar to FIG. 5 with the difference that not only one but several (three) elongate holes 26a, 26b, 26c are provided which are arranged in a row, wherein preferably a width of the elongate holes increases within this row (preferably in the direction of the distal end 19).

FIG. 7 shows a further embodiment of the flow-conducting device 12, here with a plurality of (round) openings 27. The openings 27 can (as here) be provided in several rows, wherein preferably an opening diameter in the direction of the distal end 19 (from one row to the other) increases. The number of each individual row can remain the same or (as shown in FIG. 7) decrease. FIG. 8 shows some further embodiments of the flow-conducting device 12, here with several rows of triangular openings 28 (specifically three rows with three openings 28 each, but deviations are feasible). The triangles are aligned in the direction of the distal end 19.

FIG. 9 shows a further embodiment of a heater according to the invention. In the embodiment according to FIG. 9, a flow-deflecting and/or turbulence-generating device 25 is shown which, in addition to the (optionally provided) structures 21a, 21b, 23, 24 according to FIG. 4 has (flap-like) projections 31, 32. The projections 31, 32 are preferably aligned in this case so that they are directed (skew) downstream or upstream (relative to a respective principal or primary flow direction). The projection 31 can in this case be arranged in a half of a corresponding inflow surface 33 arranged downstream (according to the course of the primary flow). The same can apply for the projection 32 relative to the (opposite) inflow surface 34. Alternatively, the projection 31 can be arranged in an upstream (when the course of the primary flow is reversed) half of a corresponding inflow surface 33. The same can apply for the projection 32 relative to the (opposite) inflow surface 34.

A further heater according to the invention is shown in FIG. 12. This fundamentally corresponds to the embodiment according to FIGS. 9 to 11. Instead of the projections 31, 32 (which however can be additionally provided), a (cylindrical) turbulator 44 is provided here, which extends perpendicularly with respect to a principal plane of the flow-conducting device 12 (preferably in both directions).

FIGS. 15 and 16 illustrate further embodiments of the heater according to the invention (in sections and in cross-section).

According to FIG. 15, a section of the heating element 16 can be arranged between two sections 37, 38 of a flow-conducting device 12. The sections 37, 38 form wall sections with corresponding openings 39 running parallel to one another. The openings 39 are aligned with one another in the embodiment according to FIG. 15.

Alternatively (see FIG. 16), the openings 39 can run offset with respect to one another at least in the longitudinal direction (relative to the section of the heating element 16 running between the sections 37, 38) (alternatively or additionally, also in the transverse direction). The section of the heating element 16 shown here is preferably round in cross-section or forms a cylinder section.

FIG. 18 shows a further heater according to the invention (in sections; in oblique view). The heater here has a plate-shaped flow-conducting device 12, wherein a (spiral) heating conductor 16 is arranged on both sides. The flow-conducting device 12 is configured as a perforated plate (perforated sheet) with a plurality of (preferably at least ten) holes 40.

Liquid inlet 13 and liquid outlet 14 are here configured to be offset with respect to one another in the longitudinal direction of the housing 10. As a result, the amount of heat can be further improved.

FIG. 19 shows (in sections) a further embodiment of the electric heater according to the invention. The flow-conducting device 12 is here configured as a perforated cylinder (circular cylinder). This cylinder preferably extends in the same direction as corresponding tubular heating coil sections 42.

At this point, it should be noted that all the above-described parts when viewed by themselves are claimed as essential to the invention in any combination, in particular the details shown in the drawings. Amendments to this are familiar to the person skilled in the art.

### REFERENCE LIST

10 Housing
11 Flange part (cover)
12 Flow-conducting device (flow-conducting element)
12a Flow-conducting device
13 Liquid inlet
14 Liquid outlet
15 Volume
16 Heating element
17 Partial volume
18 Partial volume
19 Distal end
20a Clamping device
20b Clamping device
21a Clearance (recess)
21b Clearance (recess)
22 Main body
23 Tab
24 Tab
25 Flow-deflecting and/or turbulence-generating device
26 Elongate hole
26a Elongate hole
26b Elongate hole
26c Elongate hole
27 (Round) opening
28 (Triangular) opening
29 Impact element
30 Impact element
31 Projection
32 Projection
33 Inflow surface
34 Inflow surface
37 Section
38 Section
39 Opening
40 Hole
41 Edge
44 Turbulator

1. Electric heater for a motor vehicle, comprising a volume for receiving and conducting a liquid, as well as a liquid inlet and a liquid outlet in such a manner that liquid can flow into the volume via the liquid inlet and can flow out via the liquid outlet, wherein at least one heating element and a flow-conducting device is disposed in the volume, wherein the flow-conducting device comprises at least one flow-deflecting and/or turbulence-generating device for deflecting the flow and/or for generating turbulence.

2. Electric heater, according to claim 1, for a motor vehicle, comprising a volume for receiving and conducting a liquid, as well as a liquid inlet and a liquid outlet in such a manner that liquid can flow into the volume via the liquid inlet and can flow out via the liquid outlet, wherein at least one heating element and a flow-conducting device is disposed in the volume, wherein the flow-conducting device is detachably connected to a main body of the electric heater.

3. Electric heater according to claim 1 or 2,
wherein
the flow-conducting device comprises a deflecting device in such a manner that liquid flowing from the liquid inlet to the liquid outlet is deflected so that a flow path is enlarged.

4. Electric heater according to claim 1,
wherein
the flow-conducting device and/or the main body has/have at least one clamping device, in particular plug in flap, which cooperates/cooperate with at least one corresponding device in such a manner that the flow-conducting device is held in a clamping manner.

5. Electric heater according to claim 1,
wherein
the flow-deflecting and/or turbulence-generating device has at least one opening, and/or at least one recess, and/or at least one projection, wherein the at least one projection projects from the flow-conducting device.

6. Electric heater according to claim 1,
wherein
the flow-deflecting and/or turbulence-generating device has at least one flap which projects from the flow-conducting device, wherein the flap is formed at least in part by a section of the flow-conducting device being at least partially cut out and/or at least partially placed thereon.

7. Electric heater according to claim 1,
wherein
the flow-deflecting and/or turbulence-generating device comprises at least one turbulator.

8. Electric heater according to claim 1,
wherein
the flow-deflecting and/or turbulence-generating device is closer to a downstream end of an inflow surface of the flow-conducting device than an upstream end or conversely.

9. Electric heater according to claim 1,
wherein
the flow-deflecting and/or turbulence-generating device is formed partially or exclusively in a distal half of the flow-conducting device.

10. Electric heater according to claim 1,
wherein
the flow-conducting device comprises at least one flow-conducting plate and/or at least one flow-conducting cylinder.

11. Electric heater according to claim 1,
wherein
the flow-conducting device has at least two wall sections which are at least substantially parallel to one another, namely a first wall section and a second wall section, between which at least one section of the heating conductor extends, wherein a first flow-deflecting and/or turbulence-generating device is provided on the first wall section and a flow-deflecting and/or turbulence-generating device is provided on the second wall section, wherein first and second turbulence-generating device are arranged offset with respect to one another or in alignment with one another.

12. Electric heater according to claim 1,
wherein
the liquid inlet and the liquid outlet are adjacent to one another and/or are arranged on the same side of the electric heater and/or are arranged offset with respect to one another.

13. Electric heater according to claim 1,
wherein
the liquid inlet and the liquid outlet have a distance from one another which is significantly smaller than a maximum possible distance between two points inside the volume.

14. Electric heater according to claim 1,
wherein
the flow path enlarged by the flow-conducting device is at least double a distance between liquid inlet and liquid outlet.

15. Electric heater according to claim 1,
wherein
the flow-conducting device divides the volume into at least two partial volumes, which are interconnected by at least one or precisely one connecting opening, wherein the connecting opening is at a greater distance from the liquid inlet than the liquid outlet and/or wherein a heating element or a section of such is arranged in both partial volumes.

16. Electric heater according to claim 1,
wherein
at least one tubular heating body and/or at least one layer heater is provided as heating element.

17. Motor vehicle comprising an electric heater according to claim 1.

18. Method for operating a heater according to claim 1, wherein the liquid flows in through the liquid inlet and flows out from the liquid outlet at elevated temperature.

19. Method according to claim 18,
wherein
the liquid flowing out from the volume is used to heat an interior of a motor vehicle.

20. Use of a heater according to claim 1 as a pre-heating device and/or additional heating device.

21. Set, comprising a heater according to claim 1, wherein the set comprises at least a first and a second flow-conducting element which differ from one another with regard to their structure by the structure of at least one turbulence-generating device.
